(19) United States
(12) Patent Application Publication
(10) Pub. No.: US 2025/0320688 A1
(43) Pub. Date: Oct. 16, 2025

(54) IMMERSED TUBE PRODUCTION SYSTEM AND PRODUCTION METHOD

(71) Applicant: CCCC FIRST HARBOR ENGINEERING CO., LTD., TIANJIN (CN)

(72) Inventors: Naishou ZHANG, TIANJIN (CN); Weiwei ZHU, TIANJIN (CN); Jinfang HOU, TIANJIN (CN); Xiangyu LIU, TIANJIN (CN); Zhipu LI, TIANJIN (CN); Chuang DU, TIANJIN (CN)

(21) Appl. No.: 19/253,558

(22) Filed: Jun. 27, 2025

Related U.S. Application Data
(63) Continuation-in-part of application No. PCT/CN2024/090289, filed on Apr. 28, 2024.

(30) Foreign Application Priority Data
May 6, 2023 (CN) 202310497615.9

(51) Int. Cl. E02D 29/073

(52) U.S. Cl. CPC E02D 29/073; E02D 2250/0023; E02D 2250/0061; E02D 2300/002

(57) ABSTRACT

The present application relates to an immersed tube production system and production method, the production system comprising: a production line, including a rebar binding area, a rebar cage storage area, an immersed tube production area and an outfitting area; a first and a second steel sealing gate are disposed at two ends of the immersed tube production area; the immersed tube production area comprises multiple pouring areas; and the outfitting area is located on a water surface of an external water area; a rebar production area, including a rebar storage area, and a bottom, sidewall and roof rebar processing areas; the rebar production area is located at a side of the rebar binding area; and the rebar binding area is configured to bind the bottom, sidewall and roof rebars into rebar cages; and first hoisting equipment, configured to transport the rebars in the rebar production area.

### CROSS-REFERENCE TO RELATED APPLICATIONS

The present application is a continuation-in-part application of the international application PCT/CN2024/090289 filed on Apr. 28, 2024, which claims the priority benefit of Chinese application No. 202310497615.9, filed on May 6, 2023, entitled “Immersed Tube Production System and Production Method”, the entireties of the above identified applications are hereby incorporated by reference.

### TECHNICAL FIELD

The present application belongs to the technical field of immersed tube production, and in particular to an immersed tube production system and production method.

### BACKGROUND ART

An underwater tunnel is a traffic method that enables to quickly pass through a water area, and an immersed tube method is a construction method of building tunnels underwater. An immersed tube tunnel is an underwater tunnel built by transporting multiple immersed tubes to a site and sinking and mounting them one by one in dredged foundation trenches.

CN217123497U discloses a factory system for assembly line prefabrication of an integral reinforced concrete immersed tube, in which rebar cages are poured with concrete to form immersed tubes, and the immersed tubes after partial pouring or complete pouring are transported by a first trolley mechanism and a second trolley mechanism on a first trolley track and a second trolley track. Because the immersed tube has an extremely large weight, the speed of moving the immersed tube is very slow; in addition, laying the first trolley track and the second trolley track and erecting the first trolley mechanism and the second trolley mechanism all require very high costs.

### SUMMARY

In order to solve some of the problems in the prior art, a first aspect of the present application provides an immersed tube production system, comprising:
a production line, including a rebar binding area, a rebar cage storage area, an immersed tube production area and an outfitting area, sequentially arranged along a first direction in horizontal; wherein the immersed tube production area is formed at the ground and located below the ground level; a first steel sealing gate and a second steel sealing gate are disposed at two ends of the immersed tube production area respectively, so that the immersed tube production area is able to be separated from the rebar cage storage area and the outfitting area; the immersed tube production area comprises a plurality of pouring areas distributed along the first direction; and the outfitting area is located on a water surface of an external water area;
a rebar production area, including a rebar storage area configured to store rebars, and a bottom rebar processing area, a sidewall rebar processing area and a roof rebar processing area disposed along the first direction and configured to process and form bottom rebars, sidewall rebars and roof rebars respectively; the rebar production area is located at a side of the rebar binding area; and the rebar binding area is configured to bind the bottom rebars, the sidewall rebars and the roof rebars into rebar cages; and
first hoisting equipment, configured to transport the rebars in the rebar production area.
wherein, the second steel sealing gate is configured to be able to prevent water from the outfitting area from entering the immersed tube production area, so that the immersed tube production area is able to be in a dry construction state; the first steel sealing gate is configured to be able to prevent water from the immersed tube production area from entering the rebar cage storage area, so that the rebar cage storage area will not be affected when the immersed tube is floating.

In the present application, the rebars in the rebar production area are processed into required lengths and shapes, and the rebars are transported to the rebar cage binding area of the production line to be bound into rebar cages. The rebar cages are transported to the rebar cage storage areas; when the immersed tube needs to be poured, a first rebar cage is transported to the pouring area farthest from the rebar cage storage area, and concrete is poured in the pouring area, and an immersed tube section is formed after the concrete is solidified; a next rebar cage is transported to the pouring area adjacent to the immersed tube section and concrete is poured, and an immersed tube section is formed after the concrete is solidified; and the above steps are repeated until a required number of immersed tube sections meets the requirements, and the plurality of immersed tube sections form an immersed tube. Sealing doors are connected at two ends of the immersed tube; subsequently, the first steel sealing gate is closed, and water is injected into the immersed tube production area to float the immersed tube on the water surface; then, the second steel sealing gate and a dock gate are opened, and the immersed tube is towed out of the immersed tube production area and the outfitting area by ships. The immersed tube is formed by the plurality of immersed tube sections, the manufacturing of the immersed tube is completed in the immersed tube production area, and no position movement is required t in the production process of the immersed tube. And, after produced, the immersed tube floats on the water surface by buoyancy, and can be towed away by ships, so that no large equipment is needed to move the immersed tube, and the cost is saved.

In an embodiment, the immersed tube production system further comprises a concrete production area disposed at a side of the immersed tube production area; wherein a concrete mixing station, a ground pump and conveying tubes are provided in the concrete production area; a number of the conveying tubes is the same as a number of the pouring areas, communicating one to one; and the conveying tubes are all connected with the concrete mixing station and the ground pump so as to provide concrete in the concrete mixing station to the pouring areas. When the immersed tube is manufactured, the concrete production area is directly provided at the side of the immersed tube production area, the concrete mixing station mixes the concrete and outputs it to the conveying tubes, the concrete is directly conveyed to the various pouring areas through the conveying tubes by the ground pump, and the concrete is not required to be transported by a tank truck, so that the cost is saved.

In an embodiment, the concrete production area further comprises a sand area, a large gravel area and a small gravel area, so as to provide the concrete mixing station with sand, large gravel and small gravel as raw materials respectively; and the sand area, the large gravel area and the small gravel area are located at a side of the concrete mixing station away from the production line. Through this arrangement, the sand, large gravel and small gravel in the sand area, large gravel area and small gravel area can be conveyed to the concrete mixing station in time, so that raw materials are reserved, the cost is further saved, and the replenishment of materials to the concrete mixing station is facilitated to avoid the problem of insufficient concrete.

In an embodiment, the immersed tube production system further comprises a fence and a dock gate; wherein the fence surrounds the outfitting area; and the dock gate and the second steel sealing gate are used for opening or closing the outfitting area, and a tower crane is provided in the outfitting area. After the immersed tube is towed to the outfitting area, measuring and pull-closing equipment can be mounted outside the immersed tube through the tower crane, so that the immersed tube can be directly mounted after being transported to a mounting position.

In an embodiment, the rebar binding area comprises a bottom rebar binding area, a sidewall rebar binding area and a roof rebar binding area, provided at intervals along the first direction and respectively configured to receive the bottom rebars, the sidewall rebars and the roof rebars from the rebar production area. The bottom rebars, the sidewall rebars and the roof rebars can be transported to the bottom rebar binding area, the sidewall rebar binding area and the roof rebar binding area respectively, so as to avoid the disorder of rebars with different specifications or rebar plates formed after binding, and improve the tidiness of production.

In an embodiment, the rebar binding area, the rebar cage storage area and the immersed tube production area are all located in a dock; the rebar production area is located outside the dock; and an exterior of the dock is higher than an interior of the dock. The outfitting area is also located in the dock, to prevent external waters outside the dock door from disturbing an outfitting process. The first direction is substantially parallel to a length direction of the immersed tube.

A second aspect of the present application provides an immersed tube production method, which adopts the immersed tube production system described in any of the previous embodiments and comprises the following steps:
rebar production: transporting rebars in the rebar storage area to the bottom rebar processing area, the sidewall rebar processing area and the roof rebar processing area by the first hoisting equipment respectively; and manufacturing the rebars into bottom rebars, sidewall rebars and roof rebars by rebar processing equipment respectively;
rebar binding: transporting the bottom rebars, the sidewall rebars and the roof rebars to the rebar binding area, and binding the bottom rebars, the sidewall rebars and the roof rebar with binding equipment to form rebar cages;
rebar cage storage: transporting the rebar cages to the rebar cage storage area;
immersed tube section production: opening the first steel sealing gate, transporting one of the rebar cages to a pouring area farthest from the rebar cage storage area, pouring concrete in the pouring area, and forming a first immersed tube section after the concrete is solidified; transporting a next rebar cage to the pouring area adjacent to the first immersed tube section and pouring concrete, and forming a second immersed tube section after the concrete is solidified; and repeating the above steps until a required number of immersed tube sections meets the requirements;
immersed tube section splicing: connecting the immersed tube sections to form an immersed tube;
immersed tube ex-factory: connecting sealing doors at two ends of the immersed tube; subsequently, closing the first steel sealing gate, and injecting water into the immersed tube production area to float the immersed tube on a water surface; then, opening the second steel sealing gate and the dock gate, and towing the immersed tube out of the immersed tube production area and the outfitting area by ships.

In the present application, the immersed tube and the immersed tube sections do not need to be moved in the process of manufacturing the immersed tube, which saves the cost. In addition, the produced immersed tube can be towed out of the outfitting area by buoyancy by ships, and then towed to a construction site through an external water area, thus saving the cost.

In an embodiment, more specifically, the rebar binding step comprises: transporting the bottom rebars, the sidewall rebars and the roof rebars to the bottom rebar binding area, the sidewall rebar binding area and the roof rebar binding area respectively; binding the bottom rebars into a bottom rebar plate in the bottom rebar binding area; transporting the bottom rebar plate to the sidewall rebar binding area and binding the sidewall rebars to the bottom rebar plate to form a semi-finished rebar cage; and transporting the semi-finished rebar cage to the roof rebar binding area and binding the roof rebars to the semi-finished rebar cage to form the finished rebar cage. The rebar cage is formed by the bottom rebar binding area, the sidewall rebar binding area and the roof rebar binding area, so that the production process is clear and the cost is saved.

In an embodiment, more specifically, the immersed tube section splicing step comprises: allowing a steel strand to pass through a prefabricated hole of each immersed tube section in turn, tightening the steel strand and fixing two ends of the steel strand, and fixing the immersed tube sections at two extreme ends with the steel strand, and allowing the steel strand to rebound to tighten each immersed tube section. Each immersed tube section is tightened by the steel strand, so that there is no need to move the immersed tube sections, and the cost is saved.

In an embodiment, more specifically, the immersed tube section splicing step comprises: firstly, allowing an elastic steel strand to pass through a prefabricated hole of each immersed tube sections in turn to connect the immersed tube sections in series; then fixing a first end of the steel strand at a first end of the two ends of the immersed tube; and tightening the steel strand at a second end of the two ends of the immersed tube, and fixing a second end of the steel strand opposite to the first end to the second end of the immersed tube after the steel strand is tightened to a predetermined degree of tightness.

In an embodiment, more specifically, in the immersed tube ex-factory step, the sealing doors are connected at the two ends of the immersed tube; then the first steel sealing gate is closed, and water is injected into the immersed tube production area to float the immersed tube on the water surface; then the second steel sealing gate is opened, the immersed tube is towed to the outfitting area, and measuring and pull-closing equipment is mounted outside the immersed tube by a tower crane; and finally, the dock gate is opened and the immersed tube is towed out of the outfitting area. The measuring and pull-closing equipment is mounted outside the immersed tube in the outfitting area by the tower crane, so that the immersed tube can be used quickly during construction.

In an embodiment, in the immersed tube ex-factory step, before the first steel sealing gate is closed and water is injected into the immersed tube production area to float the immersed tube on the water surface, the molds in the immersed tube production area are transported to the mold storage area. The molds are moved to the mold storage area before water is injected, so as to avoid the molds from being damaged by soaking in water and save the cost.

In an embodiment, more specifically, the immersed tube ex-factory step comprises: connecting the sealing doors at the two ends of the immersed tube; then closing the first steel sealing gate, keeping the second steel sealing gate closed, and injecting water into the enclosed immersed tube production area to float the immersed tube on the water surface; after the water level of the immersed tube production area is substantially flush with the water level of the outfitting area, opening the second steel sealing gate and keeping the dock gate closed, then towing the immersed tube to the outfitting area, and mounting measuring and pull-closing equipment outside the immersed tube by the tower crane (i.e. outfitting); and finally, opening the dock gate and towing the immersed tube out of the outfitting area.

In an embodiment, after the immersed tube section production step and before the immersed tube section splicing step, the immersed tube production method further comprises: mounting a sealing ring and a riveting structure between any two adjacent immersed tube sections, for sealing and butt joint respectively; and in the immersed tube section splicing step, the sealing ring and the riveting structure are further compressed.

In the immersed tube production system or the immersed tube production method provided by at least one embodiment of the present application, the immersed tube is formed by the plurality of immersed tube sections, the manufacturing of the immersed tube is completed in the immersed tube production area, and almost no position movement is required in the production process of the immersed tube. In addition, after produced, the immersed tube floats on the water surface by buoyancy, and can be towed away by ships, so that no large equipment is needed to move the immersed tube, and the cost is saved.

### BRIEF DESCRIPTION OF THE DRAWINGS

FIG. 1 is an overall schematic structural diagram of an immersed tube production system according to one embodiment;

FIG. 2 is a schematic sectional view of the immersed tube production system according to one embodiment;

FIG. 3 is a schematic flow chart of an immersed tube production method according to one embodiment;

wherein: 1 production line; 2 rebar production area; 3 first hoisting equipment; 4 rebar binding area; 5 immersed tube production area; 6 flatbed transport track; 7 second hoisting equipment; 8 concrete production area; 100 rebar storage area; 200 bottom rebar processing area; 300 sidewall rebar processing area; 400 roof rebar processing area; 500 bottom rebar binding area; 600 sidewall rebar binding area; 700 roof rebar binding area; 800 rebar cage storage area; 900 mold storage area; 110 first steel sealing gate; 120 pouring area; 130 concrete mixing station; 131 ground pump; 132 conveying tube; 140 sand area; 150 large gravel area; 160 small gravel area; 170 second steel sealing gate; 180 outfitting area; 190 fence; 210 tower crane; 220 dock gate; first direction X; and second direction Y.

### DETAILED DESCRIPTION OF THE EMBODIMENTS

The technical solutions of the present application will be described in detail below in combination with specific embodiments. However, it should be understood that elements, structures and features in one embodiment may also be advantageously incorporated into other embodiments without further description.

In the description of the present application, it should be noted that terms such as “first” and “second” are used for descriptive purposes only, and cannot be understood as indicating or implying the relative importance, or implicitly indicating the number of indicated technical features. Therefore, the features defined with “first” and “second” may explicitly or implicitly include one or more of these features.

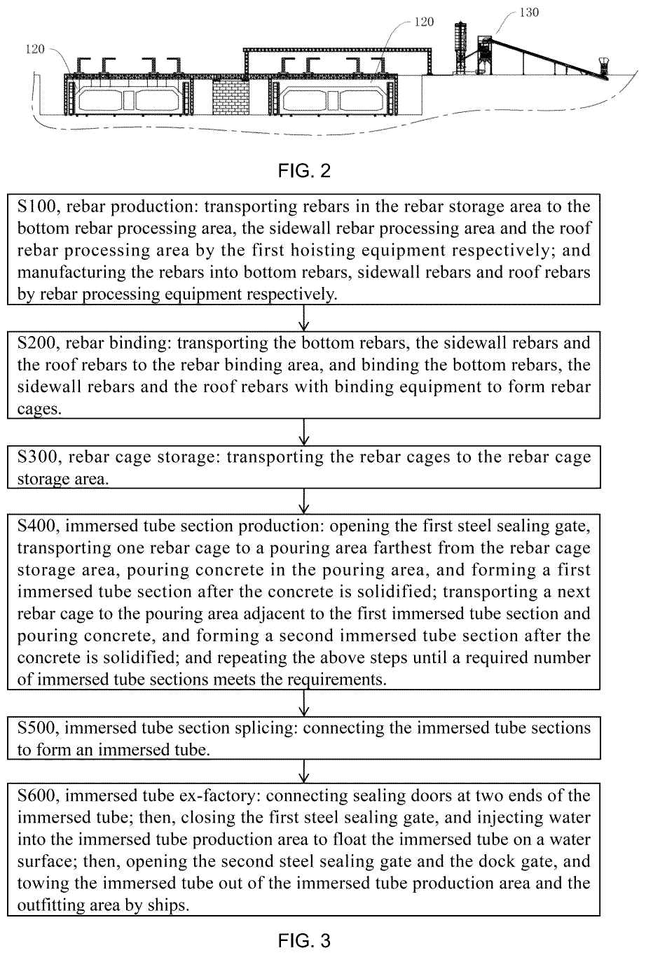

In the description of the present application, it should be noted that the terms “up”, “down”, “bottom”, “inner” and the like indicate the positional or positional relationship are based on the positional or positional relationship shown in Fig.2, merely for the convenience of describing the present application and the simplified description, but do not indicate or imply a devices or an element referred to must be of a particular orientation, constructed and operated in a particular orientation and therefore should not be construed as limiting the present application.

In the description of the present application, it should be noted that the terms “connect”, “connecting” and “connected” should be understood in a broad sense unless otherwise clearly specified and limited. For example, they might be fixed connection, detachable connection, or integrated connection; might be direct connection or indirect connection through an intermediate medium, and might be internal connection of two elements. For those of ordinary skill in the art, the specific meanings of the above-mentioned terms in the present application can be understood under specific circumstances.

In the background art, CN217123497U discloses a factory system for assembly line prefabrication of an integral reinforced concrete immersed tube. In the existing immersed tube production process, molds need to be prefabricated at a rebar cage when concrete is poured, while lengths of the molds are limited, so that in the existing patent, after the molds are placed in the rebar cage and part of the concrete is poured, the immersed tube is moved and positions of the molds are changed for re-pouring. During the movement of the immersed tube, a first trolley mechanism and a second trolley mechanism on a first trolley track and a second trolley track are used for transportation. As the immersed tube has an extremely large weight and the weight of the molded immersed tube even reaches 80,000 tons, it is extremely expensive to provide the first and the second trolley track, as well as the first and the second trolley mechanism. In order to solve this problem, the present embodiment provides an immersed tube production system and production method.

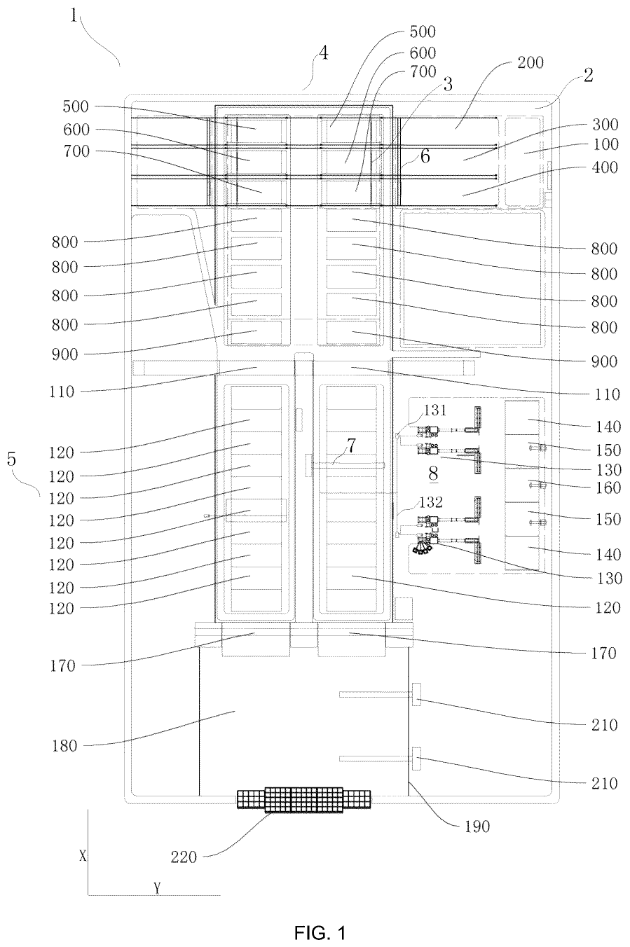

As shown in FIGS. 1 and 2, a first embodiment of the present application provides an immersed tube production system. A horizontal first direction X is set, the immersed tube production system includes: a production line 1, a rebar production area 2 and first hoisting equipment 3; wherein the production line 1 includes a rebar binding area 4, a rebar cage storage area 800, an immersed tube production area 5 and an outfitting area 180 which are sequentially arranged along the first direction X;
the immersed tube production area 5 is formed at the ground and located below the ground level; a first steel sealing gate 110 and a second steel sealing gate 170 are respectively provided at two ends of the immersed tube production area 5; and the immersed tube production area 5 is separated from the rebar cage storage area 800 and the outfitting area 180 by the first sealing door 110 and second steel sealing gate 170 respectively. The immersed tube production area 5 includes a plurality of pouring areas 120 distributed along the first direction X. The outfitting area 180 is located on a water surface of an external water area.

The rebar production area 2 includes a rebar storage area 100; and a bottom rebar processing area 200, a sidewall rebar processing area 300 and a roof rebar processing area 400 provided along the first direction X; so as to obtain rebars from the rebar storage area 100 to produce bottom rebars, sidewall rebars and roof rebars respectively. The rebar production area 2 is provided at a side of the rebar binding area 4.

The first hoisting equipment 3 is configured to transport the rebars in the rebar production area 2.

The rebar binding area 4, the rebar cage storage area 800 and the immersed tube production area 5 are sequentially provided along the first direction X, and are all provided at the ground and located below the ground level; for example, the three ones can all be located in a dry dock; and the rebar production area 2 is higher than the three ones, and is located outside the dock. In addition, the two ends of the immersed tube production area 5 are able to be separated from the rebar cage storage area 800 and the outfitting area 180 by the first steel sealing gate 110 and second steel sealing gate 170, respectively, so that water can be injected into the immersed tube production area to float the prefabricated immersed tube, and the water will not be injected into the rebar binding area 4 and the rebar cage storage area 800.

Through the above arrangement, the rebars in the rebar production area 2 are processed into required lengths and shapes, and the processed rebars are transported to the rebar binding area 4 to be bound into rebar cages. A plurality of the bound rebar cages are transported to the rebar cage storage area 800 to be temporarily stored; when an immersed tube needs to be poured, one rebar cage is transported to the pouring area 120 farthest from the rebar cage storage area 800 (i.e., the pouring area closest to the second steel sealing gate 170 and farthest from the first steel sealing gate 110), and concrete is poured in the pouring area 120, and a first immersed tube section is formed after the concrete is solidified; a next rebar cage is transported to the pouring area 120 adjacent to the first immersed tube section and concrete is poured, and a second immersed tube section is formed after the concrete is solidified; and the above steps are repeated until a required number of immersed tube sections meets the requirements, and the plurality of immersed tube sections form the immersed tube. Sealing doors are connected at two ends of the immersed tube; then, the first steel sealing gate 110 is closed, and water is injected into the immersed tube production area to float the immersed tube on the water surface; and when the water level of the immersed tube production area 5 is approximately flush with the water level of the outfitting area 180, the second steel sealing gate 170 and a dock gate 220 are opened, and the immersed tube is towed out of the immersed tube production area 5 and the outfitting area 180 by ships. The immersed tube is formed by the plurality of immersed tube sections, the manufacturing of the immersed tube is completed in the immersed tube production area 5, and no position movement is required in the production process of the immersed tube. After produced, the immersed tube floats on the water surface by buoyancy, and is towed away by ships, so that no large equipment is needed to move the immersed tube, and the cost is saved.

Specifically, a second direction Y is set, which is horizontal and perpendicular to the first direction X, several production lines 1 are provided at intervals along the second direction Y. The rebar production area 2 provides rebars for the several production lines 1. The several production lines 1 can speed up the production, and there is no need to add any new rebar production areas, thus saving the cost. As shown in FIG. 1, the first direction X is substantially parallel to a length direction of the immersed tube, and the second direction Y is substantially parallel to a width direction of the immersed tube.

In an embodiment, the rebar production area 2 is provided at a side of the production line 1 along the second direction Y. The rebar production area 2 also includes a flatbed transport vehicle (not shown in the figure) and flatbed transport tracks 6; wherein the flatbed transport tracks 6 are provided along the first direction X; and are provided at sides, close to the production line 1, of the bottom rebar processing area 200, the sidewall rebar processing area 300 and the roof rebar processing area 400. The flatbed transport vehicle is slidably provided on the flatbed transport tracks 6, and semi-finished rebars can be transported between the bottom rebar processing area 200, sidewall rebar processing area 300 and roof rebar processing area 400 respectively, so as to rationally arrange the processing areas and save the cost. The rebars in each processing area mainly come from the rebar storage area 100 and are processed in the three processing areas 200, 300 and 400. However, some small components and rebars (collectively referred to as semi-finished rebars) suitable for the bottom, sidewall and roof rebars can be processed centrally in one of the processing areas, and then they can be deployed among the three processing areas 200, 300 and 400 by using the flatbed transport vehicle, thus optimizing the space and improving the productivity.

The rebar storage area 100 can be provided at sides, away from the production line 1, of the bottom rebar processing area 200, the sidewall rebar processing area 300 and the roof rebar processing area 400. Rebars are stored through the rebar storage area 100.

The rebar binding area 4 includes a bottom rebar binding area 500, a sidewall rebar binding area 600 and a roof rebar binding area 700, provided at intervals along the first direction X. bottom rebars, sidewall rebars and roof rebars are transported to the bottom rebar binding area 500, the sidewall rebar binding area 600 and the roof rebar binding area 700 respectively, so as to avoid the disorder of rebars with different specifications or rebar plates formed after binding, and improve the tidiness of production.

Specifically, the bottom rebar processing area 200, the sidewall rebar processing area 300 and the roof rebar processing area 400 produce bottom rebars, sidewall rebars and roof rebars respectively. The first hoisting equipment 3 includes, but is not limited to, an overhead crane and a gantry crane, and is configured to transport the bottom rebars, the sidewall rebars and the roof rebars to the bottom rebar binding area 500, the sidewall rebar binding area 600 and the roof rebar binding area 700, respectively. The bottom rebars are bound into a bottom rebar plate in the bottom rebar binding area 500; the bottom rebar plate is transported to the sidewall rebar binding area 600 and the sidewall rebars are bound thereon to form a semi-finished rebar cage; and the semi-finished rebar cage is transported to the roof rebar binding area 700 and the roof rebars are bound thereon to form a finished rebar cage. The first hoisting equipment 3, the rebar binding area 4 and the rebar production area 2 provided along the second direction Y can be located indoors, such as in a factory building, so as to facilitate the mounting and protection of these equipment.

In each production line 1, a plurality of rebar cage storage areas 800 can be provided at intervals along the first direction X. The finished rebar cages are transported to the rebar cage storage areas 800, so that a situation that the rebar cages cannot be continuously produced since the rebar cages occupy the roof rebar binding area 700 can be avoided.

When there are several production lines 1, a rebar cage communication channel is formed between the rebar cage storage areas 800 of two production lines 1, to facilitate the transportation of the rebar cages between the two production lines; and when any one of the production lines is in a failure, it can work partially and cooperate with other production lines, thus saving the cost.

In FIG. 1, eight pouring areas 120 are provided at intervals along the first direction X, and four rebar cage storage areas 800 are provided; but they can be provided according to actual needs. Margins are provided at two ends of the pouring area 120 along the first direction X, providing space for mounting the sealing doors at the two ends of the immersed tube. One rebar cage is transported to one pouring area 120 farthest from the rebar cage storage area 800, concrete is poured in the pouring area 120, and a first immersed tube section is formed after the concrete is solidified; a next rebar cage is transported to the pouring area 120 adjacent to the first immersed tube section and concrete is poured, and a second immersed tube section is formed after the concrete is solidified; and the above steps are repeated until immersed tube sections are formed in all the pouring areas 120. The various immersed tube sections are spliced to form an immersed tube. The provision of the immersed tube is completed. There is no need to move the immersed tube or immersed tube sections in this process.

In an embodiment, a mold storage area 900 can further be provided at a side, adjacent to the immersed tube production area 5, of the rebar cage storage area 800, and the mold storage area 900 can also be used for placing redundant rebar cages. The mold storage area 900 is used for placing molds and electromechanical equipment. These molds mainly include a core mold and an outer mold when concrete is poured into the immersed tube; and a mobile tower crane and the like can be included.

In an embodiment, second hoisting equipment 7 can be provided at a side of the immersed tube production area 5, which can be a tower crane and a truck crane; and the molds and the electromechanical equipment in the immersed tube production area 5 are transported to the mold storage area 900 by the second hoisting equipment 7 before water injection in the immersed tube production area 5.

The immersed tube production system further includes a concrete production area 8, which is provided at a side of the immersed tube production area 5. A concrete mixing station 130, a ground pump 131 and conveying tubes 132 are provided in the concrete production area 8, wherein a number of the conveying tubes 132 is the same as the number of the pouring areas 120, communicating one to one, so as to provide concrete for pouring the immersed tube; and the conveying tubes 132 are all connected with the ground pump 131 to provide power for pumping concrete. When the immersed tube is manufactured, the concrete production area 8 is directly provided at the side of the immersed tube production area 5 along the second direction Y, the concrete mixing station 130 mixes concrete and outputs it to the conveying tubes 132, and the concrete is directly conveyed to the various pouring areas 120 through the conveying tubes by the ground pump 131, and the concrete is not required to be transported by a tank truck, so that the cost is saved.

In an embodiment, the concrete production area 8 further includes a sand area 140, a large gravel area 150 and a small gravel area 160, which are located at a side, away from the production line, of the concrete mixing station 130. Through this arrangement, sand, large gravel and small gravel stored in the sand area 140, the large gravel area 150 and the small gravel area 160 can be conveyed to the concrete mixing station 130 in time, so that raw materials are reserved, the cost is further saved, and the replenishment of materials to the concrete mixing station 130 is facilitated to avoid the problem of insufficient concrete. A particle size of the large gravel is generally greater than 32 mm, and a particle size of the small gravel is generally not greater than 32 mm, which are well known to those skilled in the art, and can also be adjusted according to the actual situation.

Further, in order to improve the concrete production, several concrete mixing stations 130 can be provided at intervals; and an example in which two mixing stations 130 are provided along the first direction X is shown in FIG. 1. In order to improve the supply of raw materials to the concrete mixing stations 130, a plurality of sand areas 140, large gravel areas 150 and small gravel areas 160 can be provided.

Specifically, when there are several production lines 1, concrete can also be transported to the pouring areas 120 of different production lines by using the ground pumps and the conveying tubes through the concrete mixing stations 130 in the concrete production area 8. In an embodiment, a road is also provided at the second steel sealing gate 170; and when the ground pump or the conveying tubes cannot convey concrete, the concrete can be transported to other production lines by a tank truck.

The immersed tube production system may further include a fence 190 and a dock gate 220, wherein an area surrounded by the fence 190 is the outfitting area 180; and the dock gate 220 and the second steel sealing gate 170 are used for opening or closing the outfitting area 180. In addition, a tower crane 210 is provided in the outfitting area 180 to mount and transport the immersed tube. After the immersed tube is towed from the immersed tube production area 5 to the outfitting area 180, measuring and pull-closing equipment can be mounted outside the immersed tube through the tower crane 210 (i.e. outfitting), so that the immersed tube can be directly mounted after being transported to a mounting position. The first steel sealing gate 110, the second steel sealing gate 170 and the dock gate 220 can be controlled through a console. In addition, an open space around the production line 1 is a standby area for temporary storage or use.

As shown in FIG. 3, a second embodiment of the present application provides an immersed tube production method, which can adopt the immersed tube production system described in any of the previous embodiments. The production method includes the following specific steps:
S100, rebar production: transporting rebars in the rebar storage area 100 to the bottom rebar processing area 200, the sidewall rebar processing area 300 and the roof rebar processing area 400 by the first hoisting equipment 3 respectively; and, in these processing areas, manufacturing the rebars into bottom rebars, sidewall rebars and roof rebars by rebar processing equipment respectively;
S200, rebar binding: transporting the bottom rebars, the sidewall rebars and the roof rebars to the rebar binding area, and binding the bottom rebars, the sidewall rebars and the roof rebars with binding equipment to form rebar cages;
S300, rebar cage storage: transporting the rebar cages to the rebar cage storage area 800;
S400, immersed tube section production: opening the first steel sealing gate 110, transporting one rebar cage to a pouring area 120 farthest from the rebar cage storage area 800, pouring concrete in the pouring area 120, and forming a first immersed tube section after the concrete is solidified; transporting a next rebar cage to the pouring area 120 adjacent to the first immersed tube section and pouring concrete, and forming a second immersed tube section after the concrete is solidified; and repeating the above steps until a required number of immersed tube sections meets the requirements;
S500, immersed tube section splicing: connecting the immersed tube sections to form an immersed tube;
S600, immersed tube ex-factory: connecting sealing doors at two ends of the immersed tube; then, closing the first steel sealing gate 110, and injecting water into the immersed tube production area 5 to float the immersed tube on a water surface; then, opening the second steel sealing gate 170 and the dock gate 220, and towing the immersed tube out of the immersed tube production area and the outfitting area 180 by ships.

In the producing process of the immersed tube, it is not necessary to move the immersed tube or the immersed tube sections, which saves the cost. In addition, the produced immersed tube can be towed out of the outfitting area 180 by buoyancy by ships, and then towed to a construction site through an external water area, thus saving the cost.

In an embodiment, when the flatbed transport tracks 6 and the flatbed transport vehicle are provided, the S100 of rebar production step further includes: centrally processing semi-finished rebars suitable for bottom rebars, sidewall rebars and roof rebars in one of the bottom rebar processing area 200, the sidewall rebar processing area 300 and the roof rebar processing area 400, and then placing the semi-finished rebars on the flatbed transport vehicle, moving along the first direction X on the flatbed transport tracks 6, so as to allot the semi-finished rebars between the bottom rebar processing area 200, the sidewall rebar processing area 300 and the roof rebar processing area 400.

In an embodiment, the S200 of rebar binding step specifically includes: transporting the bottom rebars, the sidewall rebars and the roof rebars to the bottom rebar binding area 500, the sidewall rebar binding area 600 and the roof rebar binding area 700 respectively; binding the bottom rebars into a bottom rebar plate in the bottom rebar binding area 500; transporting the bottom rebar plate to the sidewall rebar binding area 600 and binding the sidewall rebars thereon to form a semi-finished rebar cage; and transporting the semi-finished rebar cage to the roof rebar binding area 700 and binding the roof rebars thereon to form the rebar cage. The rebar cage is formed by binding in different binding areas, so that the production process is clear and the cost is saved.

In an embodiment, in the S400 of immersed tube section production step, more specifically, opening the first steel sealing gate 110, transporting one rebar cage to the pouring area 120 farthest from the rebar cage storage area 800, mounting molds on the rebar cage, pouring concrete in the pouring area 120, forming the first immersed tube section after the concrete is solidified, and removing the molds; transporting the next rebar cage to the pouring area 120 adjacent to the first immersed tube section, mounting the molds on the rebar cage and pouring concrete, forming the second immersed tube section after the concrete is solidified, and removing the molds; and repeating the above steps until the required number of immersed tube sections meets the requirements. In other embodiments, the above steps can be repeated until immersed tube sections are formed in all the pouring areas 120.

In an embodiment, after the S400 of immersed tube section production step and before the S500 of immersed tube section splicing step, the method further includes: mounting a sealing ring and a riveting structure between any two adjacent immersed tube sections, wherein the sealing between the two adjacent immersed tube sections can be realized by the sealing ring, and the alignment and butt joint between the two adjacent immersed tube sections can be realized by the riveting structure.

In an embodiment, in the S500 of immersed tube section splicing step, more specifically, allowing a steel strand to pass through a prefabricated hole of each immersed tube section in turn, tightening the steel strand and fixing two ends of the steel strand, and fixing the immersed tube sections at two extreme ends with the steel strand, and allowing the steel strand to rebound to tighten each immersed tube section. Each immersed tube section is tightened by the steel strand, so that there is no need to move the immersed tube sections, and the cost is saved.

More specifically, the steel strand is elastic, and during construction, firstly, the elastic steel strand penetrates into the prefabricated holes of the various immersed tube sections to connect the various immersed tube sections in series; then a first end of the steel strand is fixed at a first end of the two ends of the immersed tube with a riveting tool; and the steel strand is tightened at a second end of the two ends of the immersed tube, and a second end of the steel strand opposite to the first end is fixed at the second end of the immersed tube with the riveting tool after the steel strand is tightened to a predetermined degree of tightness. Through this arrangement, the first end of the steel strand is fixed at the first end of the immersed tube, and the second end of the steel strand is fixed at the second end of the immersed tube (the first end and the second end are two endmost parts oppositely arranged), and the steel strand in the immersed tube is in a tightened state, so that the various immersed tube section are tightened, to replace a technology of connecting the immersed tube sections with a post-cast strip in the prior art. In addition, after the steel strand is tightened, the riveting structure between adjacent immersed tube sections is compressed, so that a gap between immersed tube sections is smaller, and a sealing effect of sealing rings between adjacent immersed tube sections is better.

The steel strand can pass through the prefabricated hole of each immersed tube sections in turn by using a threading machine. In addition, there can be multiple steel strands; therefore, in step S500, the multiple steel strands all pass through the prefabricated holes of each immersed tube sections. One end (the second end) of the steel strand can be tightened by a winch or tensioning equipment (such as a jack).

In an embodiment, in the S600 of immersed tube ex-factory step, the opening the second steel sealing gate 170 and the dock gate 220 and towing the immersed tube out of the immersed tube production area and the outfitting area 180 by ships specifically includes: opening the second steel sealing gate 170, towing the immersed tube to the outfitting area 180, and mounting measuring and pull-closing equipment outside the immersed tube by the tower crane 210; opening the dock gate 220 and towing the immersed tube out of the outfitting area 180. The measuring and pull-closing equipment is mounted outside the immersed tube in the outfitting area 180 by the tower crane 210, so that the immersed tube can be used quickly during construction.

In an embodiment, in the S600 of immersed tube ex-factory step, before closing the first steel sealing gate 110 and injecting water into the immersed tube production area to float the immersed tube on the water surface, the method includes: transporting the molds in the immersed tube production area to the mold storage area 900, so as to avoid the molds from being damaged by soaking in water and save the cost. Specifically, the molds and the electromechanical equipment can be transported to the mold storage area 900 by the second hoisting equipment 7.

In an embodiment, more specifically, the S600 of immersed tube ex-factory step includes: connecting sealing doors at two ends of the immersed tube, and transporting the molds in the immersed tube production area 5 to the mold storage area 900 adjacent to the rebar cage storage area 800; subsequently, closing the first steel sealing gate 110, keeping the second steel sealing gate 170 closed, and injecting water into the enclosed immersed tube production area 5 to float the immersed tube on the water surface; after the water level of the immersed tube production area 5 is substantially flush with the water level of the outfitting area 180, opening the second steel sealing gate 170 and keeping the dock gate 220 closed and then towing the immersed tube to the outfitting area 180 for outfitting; and after the outfitting is completed, opening the dock gate 220 and towing the immersed tube out of the outfitting area 180. The water levels of the immersed tube production area 5 and the outfitting area 180 are flush, so that unstable transportation caused by the impact of the water potential in the outfitting area 180 to the immersed tube after the second steel sealing gate 170 is opened can be prevented; and the dock gate 220 is kept closed during immersed tube outfitting, so that external waves can be prevented from affecting the stability of outfitting construction, which is not conducive to construction.

In the present application, after the immersed tube is manufactured, it is towed out of the outfitting area by tugboats, and the immersed tube enters the external water area and is transported to the construction site. The external water area includes but is not limited to a river, a lake, a sea, an ocean and a canal. In addition, the various embodiments in the specification are described in a progressive way, and each embodiment focuses on the differences from other embodiments, so it is only necessary to refer to the same and similar parts between the embodiments.

The embodiments are only described as preferred embodiments of the present application, and are not intended to limit the scope of the present application. Various modifications and improvements made on the technical solutions of the present application by ordinary skill in the art without departing from the design spirit of the present application shall fall within the protective scope confirmed by the claims of the present application.

1. An immersed tube production system, wherein, comprising:
a production line, including a rebar binding area, a rebar cage storage area, an immersed tube production area and an outfitting area, sequentially arranged along a first direction in horizontal; wherein the immersed tube production area is formed at a ground and located below a ground level; a first steel sealing gate and a second steel sealing gate are disposed at two ends of the immersed tube production area respectively, so that the immersed tube production area is able to be separated from the rebar cage storage area and the outfitting area; the immersed tube production area comprises a plurality of pouring areas distributed along the first direction; and the outfitting area is located on a water surface of an external water area;
a rebar production area, including a rebar storage area configured to store rebars, and a bottom rebar processing area, a sidewall rebar processing area and a roof rebar processing area disposed along the first direction and configured to process and form bottom rebars, sidewall rebars and roof rebars respectively; the rebar production area is located at a side of the rebar binding area; and the rebar binding area is configured to bind the bottom rebars, the sidewall rebars and the roof rebars into rebar cages; and
first hoisting equipment, configured to transport the rebars in the rebar production area;
wherein, the second steel sealing gate is configured to be able to prevent water from the outfitting area from entering the immersed tube production area, so that the immersed tube production area is able to be in a dry construction state; and the first steel sealing gate is configured to be able to prevent water from the immersed tube production area from entering the rebar cage storage area, so that the rebar cage storage area will not be affected when the immersed tube is floating.

2. The immersed tube production system according to claim 1, wherein, the rebar binding area, the rebar cage storage area and the immersed tube production area are all located in a dock, and the rebar production area is located outside the dock, and an exterior of the dock is higher than an interior of the dock; the first direction is substantially parallel to a length direction of the immersed tube.

3. The immersed tube production system according to claim 2, wherein, the outfitting area is also located in the dock.

4. The immersed tube production system according to claim 1, wherein, further comprises a concrete production area disposed at a side of the immersed tube production area; a concrete mixing station, a ground pump and conveying tubes are provided in the concrete production area; a number of the conveying tubes is the same as a number of the pouring areas, communicating one to one; and the conveying tubes are all connected with the concrete mixing station and the ground pump so as to provide concrete in the concrete mixing station to the pouring areas.

5. The immersed tube production system according to claim 4, wherein, the concrete production area further comprises a sand area, a large gravel area and a small gravel area, all located at a side of the concrete mixing station away from the production line.

6. The immersed tube production system according to claim 1, wherein, the rebar binding area comprises a bottom rebar binding area, a sidewall rebar binding area and a roof rebar binding area, provided at intervals along the first direction and respectively configured to receive the bottom rebars, the sidewall rebars and the roof rebars from the rebar production area.

7. The immersed tube production system according to claim 1, wherein, further comprises a fence and a dock gate; an area surrounded by the fence forms the outfitting area; and the dock gate and the second steel sealing gate are used for opening or closing the outfitting area, and a tower crane is provided in the outfitting area.

8. The immersed tube production system according to claim 2, wherein, further comprises a concrete production area disposed at a side of the immersed tube production area; a concrete mixing station, a ground pump and conveying tubes are provided in the concrete production area; a number of the conveying tubes is the same as a number of the pouring areas, communicating one to one; and the conveying tubes are all connected with the concrete mixing station and the ground pump so as to provide concrete in the concrete mixing station to the pouring areas.

9. The immersed tube production system according to claim 2, wherein, the rebar binding area comprises a bottom rebar binding area, a sidewall rebar binding area and a roof rebar binding area, provided at intervals along the first direction and respectively configured to receive the bottom rebars, the sidewall rebars and the roof rebars from the rebar production area.

10. The immersed tube production system according to claim 2, wherein, further comprises a fence and a dock gate; an area surrounded by the fence forms the outfitting area; and the dock gate and the second steel sealing gate are used for opening or closing the outfitting area, and a tower crane is provided in the outfitting area.

11. An immersed tube production method, adopting the immersed tube production system in claim 1, wherein, comprising the following steps:
rebar production: transporting rebars in the rebar storage area to the bottom rebar processing area, the sidewall rebar processing area and the roof rebar processing area by the first hoisting equipment respectively; and manufacturing the rebars into bottom rebars, sidewall rebars and roof rebars respectively;
rebar binding: transporting the bottom rebars, the sidewall rebars and the roof rebars to the rebar binding area, and binding the bottom rebars, the sidewall rebars and the roof rebar to form rebar cages;
rebar cage storage: transporting the rebar cages to the rebar cage storage area;
immersed tube section production: opening the first steel sealing gate, transporting one of the rebar cages to a pouring area farthest from the rebar cage storage area, pouring concrete in the pouring area, and forming a first immersed tube section after the concrete is solidified; transporting a next rebar cage to a pouring area adjacent to the first immersed tube section and pouring concrete, and forming a second immersed tube section after the concrete is solidified; and repeating until a required number of immersed tube sections meets the requirements;
immersed tube section splicing: connecting the immersed tube sections to form an immersed tube;
immersed tube ex-factory: connecting sealing doors at two ends of the immersed tube; subsequently, closing the first steel sealing gate, and injecting water into the immersed tube production area to float the immersed tube; then, opening the second steel sealing gate and a dock gate, and towing the immersed tube out of the immersed tube production area and the outfitting area.

12. The immersed tube production method according to claim 11, wherein, the rebar binding area comprises a bottom rebar binding area, a sidewall rebar binding area and a roof rebar binding area, provided at intervals along the first direction; the rebar binding step comprises: transporting the bottom rebars, the sidewall rebars and the roof rebars to the bottom rebar binding area, the sidewall rebar binding area and the roof rebar binding area respectively; binding the bottom rebars into a bottom rebar plate in the bottom rebar binding area; transporting the bottom rebar plate to the sidewall rebar binding area and binding the sidewall rebars to the bottom rebar plate to form a semi-finished rebar cage; and transporting the semi-finished rebar cage to the roof rebar binding area and binding the roof rebars to the semi-finished rebar cage to form a finished rebar cage.

13. The immersed tube production method according to claim 11, wherein, more specifically, the immersed tube ex-factory step comprises: connecting the sealing doors at the two ends of the immersed tube, transporting molds in the immersed tube production area to a mold storage area adjacent to the rebar cage storage area; then closing the first steel sealing gate, keeping the second steel sealing gate closed, and injecting water into the enclosed immersed tube production area to float the immersed tube; after a water level of the immersed tube production area is substantially flush with a water level of the outfitting area, opening the second steel sealing gate and keeping the dock gate closed, then towing the immersed tube to the outfitting area, and outfitting the immersed tube; and finally, opening the dock gate and towing the immersed tube out of the outfitting area.
